(19) United States
(12) Patent Application Publication
(10) Pub. No.: US 2012/0268071 A1
(43) Pub. Date: Oct. 25, 2012

(54) MAGNETIC FUEL CELL-BASED BATTERY

(76) Inventors: FU-TZU HSU, Taipei City (TW); Chien-Sen Tu, New Taipei City (TW)

(21) Appl. No.: 13/092,423

(22) Filed: Apr. 22, 2011

(51) Int. Cl. H02J 7/00

(52) U.S. Cl. 320/128

(57) ABSTRACT

A magnetic fuel cell-based battery includes a buffer battery unit; a static magnetic field unit including permanent magnets for amplifying electric energy; a potential to kinetic energy converting unit for generating an electrical resonance effect of oscillating eddy current to replace magnetic field shifting; a magnetic fuel cell stack forming unit including a magnetoresistance element constituted by a Hall element and achieving Hall Effect and forming a cell stack through amplification by a magnetic field effect of the permanent magnets of the static magnetic field unit; and a rectifying and charging unit for rectifying and charging the cell stack formed by the magnetic fuel cell stack forming unit to the buffer battery unit to form a permanent battery. Therefore, the magnetic fuel cell-based battery is a permanent battery formed by combining a buffer battery unit with a magnetic fuel cell stack forming unit that uses permanent magnets as fuel body.

### FIELD OF THE INVENTION

The present invention relates to a magnetic fuel cell-based battery that uses permanent magnets as the fuel body thereof and utilizes Hall Effect-based magnetoresistance effect; and more particularly to a magnetic fuel cell-based battery that utilizes an interactive action between a potential energy produced by a static magnetic field unit and an eddy current energy (kinetic energy) to form a magnetic fuel cell stack forming unit so as to out-couple an electric field, and uses a rectifying and charging unit to charge the electric field to a buffer battery unit to form a permanent battery.

### BACKGROUND OF THE INVENTION

FIG. 1 schematically shows a conventional Hall Effect structure, in which a magnetoresistance 10 is electrically applies a potential energy (electric field) to two electric field inputting ends 12, 13, a kinetic energy magnetic field 11 and the magnetoresistance 10 are shifted to produce a potential difference at two potential outputting ends 14, 15. Therefore, the conventional Hall Effect structure is suitable for use as a signal sensor. The magnetoresistance 10 in the conventional Hall Effect under electric connection microscopically forms a cell stack forming unit dv/dt. However, this type of cell stack forming unit would consume a large amount of kinetic energy for magnetic field shifting when forming the cell stack and therefore can not form electric power but is suitable for use as a signal sensor.

### SUMMARY OF THE INVENTION

A primary object of the present invention is to provide a magnetic fuel cell-based battery that utilizes an interaction between a Hall Effect-based magnetoresistance and a static magnetic field unit to form a magnetic fuel cell stack forming unit, so as to out-couple an electric field, which is then rectified and charged by a rectifying and charging unit to a buffer battery unit for form a permanent battery.

The magnetic fuel cell-based battery according to the present invention includes a buffer battery unit, a static magnetic field unit, a potential to kinetic energy converting unit, a magnetic fuel cell stack forming unit, a rectifying and charging unit. The buffer battery unit is a rechargeable battery that can be repeatedly charged and discharged. The static magnetic field unit includes at least a permanent magnet capable of achieving the effect of amplifying electric energy. The potential to kinetic energy converting unit is actuated by power supply output by the buffer battery unit and is able to generate an electrical resonance effect of oscillating eddy current to replace magnetic field shifting. The magnetic fuel cell stack forming unit includes a magnetoresistance element composed of a Hall element and achieves the Hall Effect and forms a cell stack through a magnetic field effect of the permanent magnet 211 of the static magnetic field unit 21 that amplifies electric energy. The rectifying and charging unit is capable of rectifying the cell stack formed by the magnetic fuel cell stack forming unit and charging the cell stack to the buffer battery unit, so that the cell stack is stored in the buffer battery unit to form a permanent battery.

In the magnetic fuel cell-based battery according to the present invention, the potential to kinetic energy converting unit is mainly constituted by tunnel diodes for converting an electric field into an eddy current field.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 schematically shows a conventional Hall Effect structure;

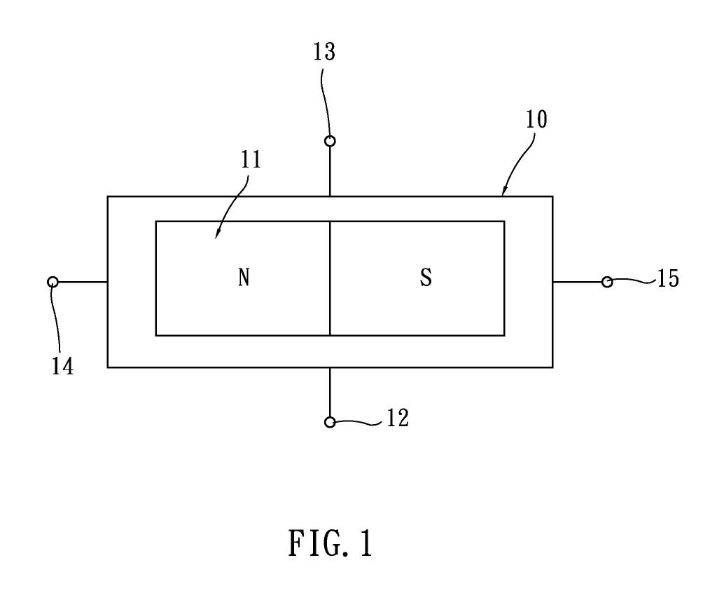

FIG. 2 is a block diagram showing the structure system of a magnetic fuel cell-based battery according to the present invention;

FIG. 3 is a schematic circuit diagram of a renewal energy magnetic fuel cell stack forming unit for the magnetic fuel cell-based battery according to the present invention;

FIG. 4 is a schematic circuit diagram of the magnetic fuel cell-based battery of the present invention;

FIG. 5 is a characteristic curve of a tunnel diode; and

FIG. 6 is a circuit diagram of a renewal energy magnetic fuel cell stack forming unit using a solid-state inductance according to an embodiment of the present invention.

### DETAILED DESCRIPTION OF THE PREFERRED EMBODIMENTS

The present invention relates to a magnetic fuel cell-based battery, which uses Hall Effect as a basis and uses kinetic energy instead of magnetic field shifting to produce magnetoelectric cogeneration effect, so as to generate and amplify electric energy. In the present invention, kinetic energy is used to replace potential energy for acting upon magnetoresistance, so that the magnetic field is, from the very beginning, a potential energy while the electric field is changed to an eddy current field (i.e. a kinetic energy), that is, Δi/Δt; and correspondingly, the output end is Δv/Δt. In this case, what is output is a potential difference, which is, macroscopically speaking, an electric field, to thereby constitute a magnetic fuel cell stack forming unit.

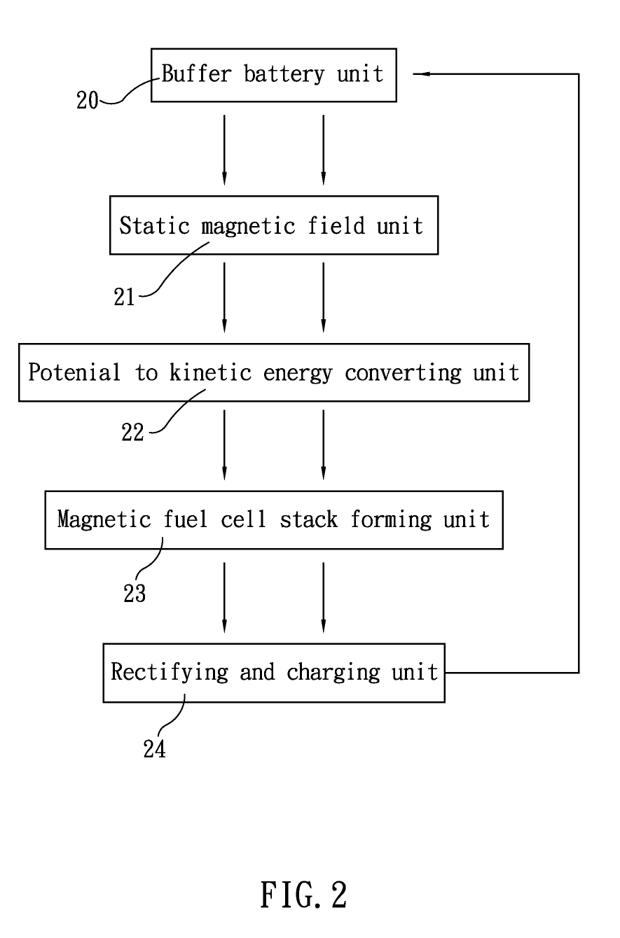

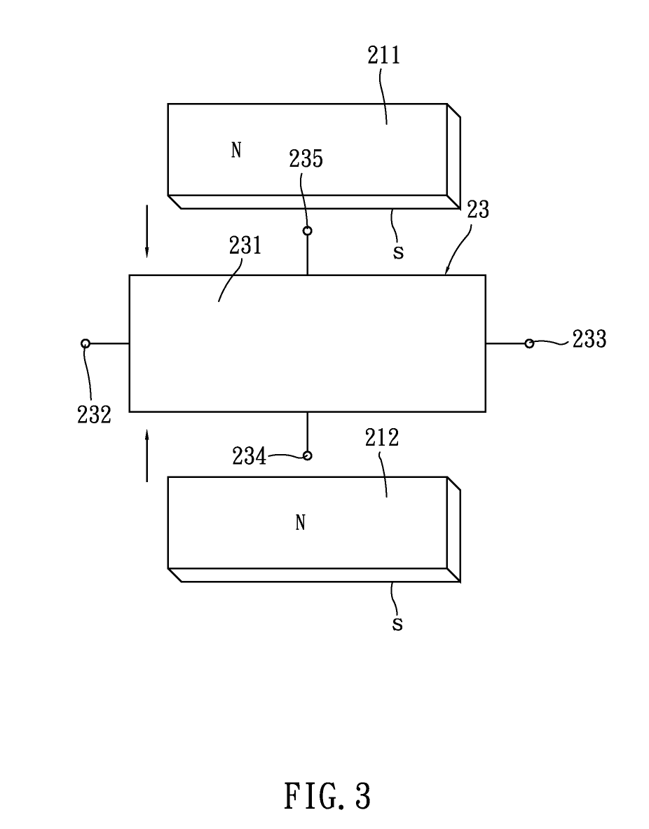

Please refer to FIGS. 2 and 3. The magnetic fuel cell-based battery according to the present invention structurally includes a buffer battery unit 20, a static magnetic field unit 21, a potential to kinetic energy converting unit 22, a magnetic cell stack forming unit 23, and a rectifying and charging unit 24. The buffer battery unit 20 is a rechargeable battery that can be repeatedly charged and discharged. The static magnetic field unit 21 includes at least one magnet (two magnets 211, 212 are shown), which is able to amplify electric energy. The potential to kinetic energy converting unit 22 is actuated by power supply output from the buffer battery unit and is able to generate an electrical resonance effect of oscillating eddy current to thereby replace magnetic field shifting. The magnetic fuel cell stack forming unit 23 includes a magnetoresistance element 231 composed of a Hall element, and achieves the Hall Effect and forms a cell stack through a magnetic field effect of the permanent magnet 211 of the static magnetic field unit 21 that amplifies electric energy. The rectifying and charging unit 24 is capable of rectifying the cell stack formed by the magnetic fuel cell stack forming unit and charging the cell stack to the buffer battery unit 20, so that the buffer battery unit 20 stores the magnetic fuel cell stack to form a permanent battery.

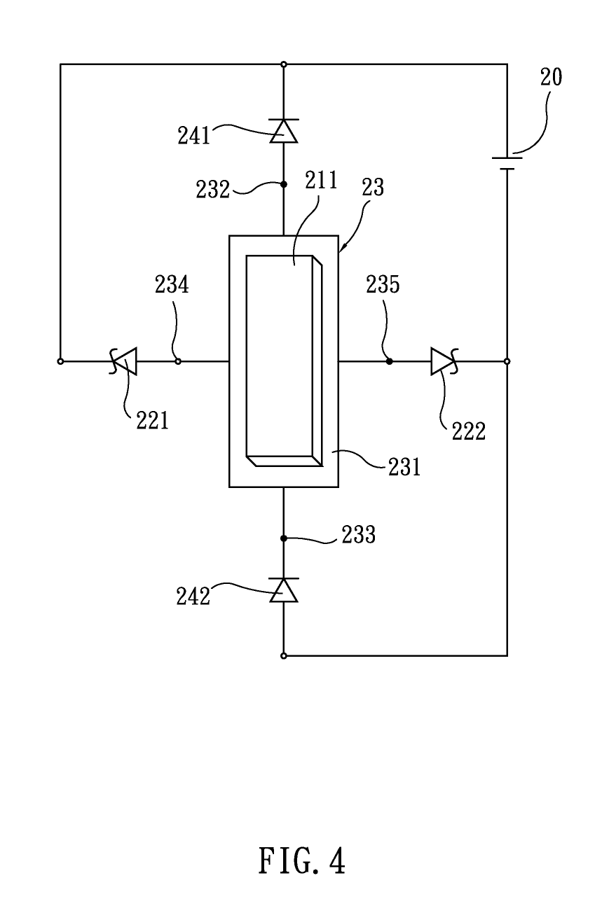

As having been mentioned above, in the present invention, a kinetic energy instead of a potential energy is used to act upon the magnetoresistance element 231. As shown in FIGS. 3 and 4, the magnetoresistance element 231 and the permanent magnets 211, 212 forming the static magnetic field unit 21 provide a potential energy. In this case, what is input to two eddy current field inputting ends 234, 235 of the magnetic fuel cell stack forming unit 23 is an electric field, which is a kinetic energy. That is, the inputting ends 234, 235 input an eddy current field, which interacts with the magnetic field for two outputting ends 232, 233 of the magnetic fuel cell stack forming unit 23 to output a cell stack. The output cell stack is then rectified by the rectifying and charging unit 24 and charged to the buffer battery unit 20, so that the buffer battery unit 20 forms a permanent battery.

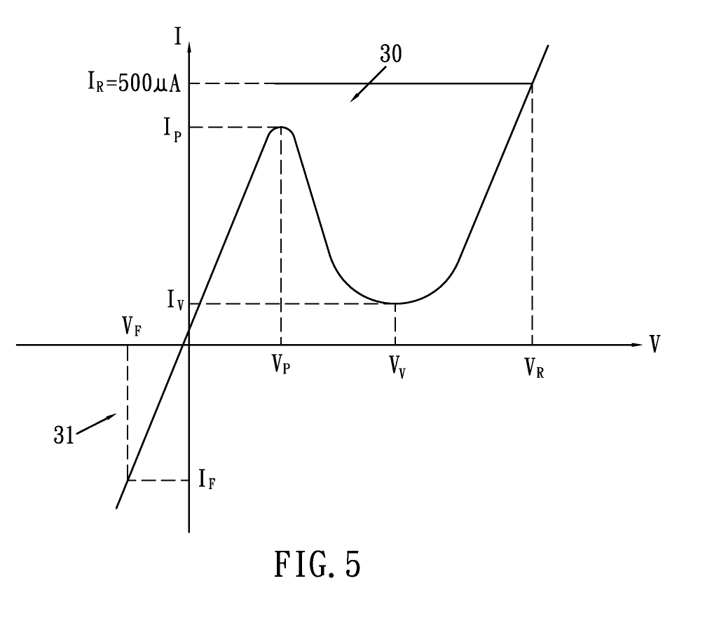

FIG. 5 is a characteristic curve of a tunnel diode. Reference numeral 30 denotes a forward characteristic curve while reference numeral 31 denotes a reverse characteristic curve. From the characteristic curve of the tunnel diode, it is found a negative damping effect is associated with the magnetoresistance element 231. That is, as shown in FIG. 4, with opposite polarity connection, two paired tunnel diodes 221, 222 are respectively connected to the two eddy current field inputting ends 234, 235 of the magnetoresistance element 231 in series to form the magnetic fuel cell stack forming unit 23; and, with same polarity connection, two paired Schottky barrier diodes 241, 242 are respectively connected to two magnetic fuel cell stack outputting ends 232, 233 of the magnetoresistance element 231 in series to output the magnetic fuel cell stack to the repeatedly chargeable and dischargeable buffer battery unit 20.

In the embodiment illustrated in FIG. 4, the potential to kinetic energy converting unit 22 is formed of tunnel diodes 221, 222 for converting the electric field into the eddy current field, and the rectifying and charging unit 24 is formed of Schottky barrier diodes 241, 242 for outputting the magnetic fuel cell stack.

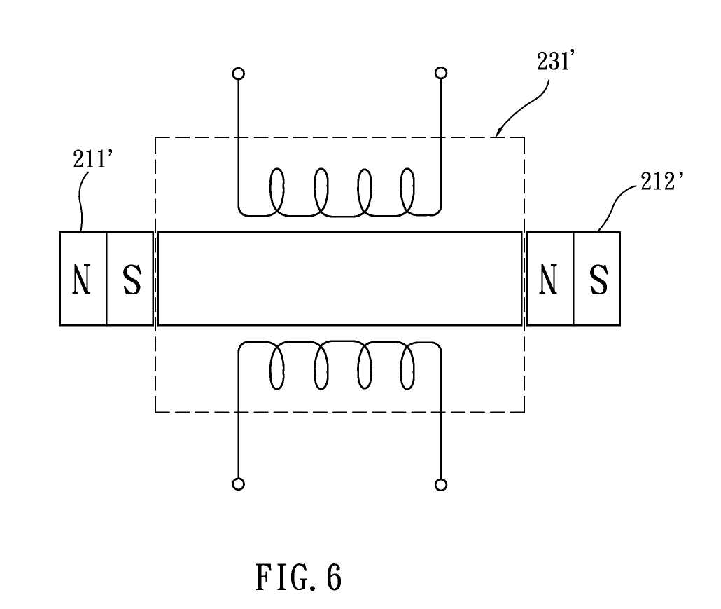

Please refer to FIG. 6. In another embodiment of the present invention, the magnetoresistance element 231 of the magnetic fuel cell stack forming unit 23 is implemented by using a solid-state inductance 231′ to replace the magnetoresistance effect of the magnetoresistance element 231 shown in FIG. 4. That is, in another embodiment of the present invention, the magnetic fuel cell stack forming unit 23 includes a solid-state inductance 231′ that constitutes a magnetoresistance element. The magnetoresistance element constituted by the solid-state inductance 231′ achieves the Hall Effect and forms the cell stack through a magnetic field effect of two permanent magnets 211′, 212′ that amplifies electric energy. That is, when using a load, an anti-electromotive force and eddy current produced by the load is input to the eddy current inputting ends 234, 235 shown in FIG. 4; and a potential magnetic field effect of the static magnetic field unit 21 charges the formed magnetic fuel cell stack back to the buffer battery unit 20. In this manner, it is able to recycle and utilize renewal energy to achieve the equilibrium stated in the first law of thermodynamics.

The magnetoresistance element constituted by the solid-state inductance 231′ as shown in FIG. 6 is able to use renewal energy as a kinetic energy input, and outputs a potential difference (i.e. an electric field) that forms the magnetic fuel cell stack body. That is, the magnetoresistance element constituted by the solid-state inductance 231′ uses the anti-electromotive force and eddy current produced by any kind of switching controller due to a load effect as a kinetic energy input for forming a magnetic fuel cell stack. To cooperate with the magnetoresistance effect of the solid-state inductance 231′, the static magnetic field unit 21 includes at least one permanent magnet 211′, 212′ to form a magnetic-field resonance effect and achieve the purpose of amplifying electric energy. With a magnetoresistance element constituted by the solid-state inductance 231′, the magnetic fuel cell stack forming unit 23 can have a mechanism being an electric damper of a switching controller to extract the anti-electromotive force and eddy current to replace the magnetic field shifting.

The potential to kinetic energy converting unit 22 can also be constituted by an electric damper of a switching controller; and the anti-electromotive force and eddy current out-coupled by a damping effect of the electrical damper can serve as a kinetic energy input. Regarding the damping effect, please refer to Taiwan Invention Patent Laid-open Gazette No. 201018084 entitled “An Electrical Damper”. Such an electrical damper can be used to enable dynamic impedance matching, to derive and construct an order-infinite resonant tank, to solve the problem of system duality, to facilitate the stabilization of a non-linear dynamic system, including dynamic power factor adjustment and dynamic adaptive damper as well as adaptive full-pass filter, all of which can be completely analyzed.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A magnetic fuel cell-based battery, which uses permanent magnets as a fuel body thereof and utilizes a Hall Effect-based magnetoresistance effect, comprising:
a buffer battery unit being a rechargeable battery that can be repeatedly charged and discharged;
a static magnetic field unit including at least one permanent magnet and being used to amplify electric energy;
a potential to kinetic energy converting unit being actuated by power supply output from the buffer battery unit and being able to generate an electrical resonance effect of oscillating eddy current to replace magnetic field shifting;
a magnetic fuel cell stack forming unit including a magnetoresistance element composed of a Hall element for outputting an electric field (i.e. a potential difference) to serve as a magnetic fuel cell stack body; wherein the electric field (potential difference) output by the magnetic fuel cell stack forming unit is amplified by a magnetic field effect of the permanent magnet of the static magnetic field unit to achieve the Hall effect and form a cell stack; and
a rectifying and charging unit being capable of rectifying the cell stack formed by the magnetic fuel cell stack forming unit and charging the cell stack to the buffer battery unit.

2. The magnetic fuel cell-based battery as claimed in claim 1, wherein the potential to kinetic energy converting unit includes tunnel diodes, which convert an electric field into an eddy current field for serving as a kinetic energy input.

3. The magnetic fuel cell-based battery as claimed in claim 1, wherein the rectifying and charging unit includes Schottky barrier diodes for outputting the magnetic fuel cell stack.

4. A magnetic fuel cell-base battery, which uses permanent magnets as a fuel body thereof and utilizes a Hall Effect-based magnetoresistance effect, comprising:
a buffer battery unit being a rechargeable battery that can be repeatedly charged and discharged;
a static magnetic field unit including at least one permanent magnet and being used to amplify electric energy;
a potential to kinetic energy converting unit being actuated by power supply output from the buffer battery unit and being able to generate an electrical resonance effect of oscillating eddy current to replace magnetic field shifting;
a magnetic fuel cell stack forming unit including a solid-state inductance that constitutes a magnetoresistance element for outputting an electric field (i.e. a potential difference) to serve as a magnetic fuel cell stack body; wherein the electric field (potential difference) output by the magnetic fuel cell stack forming unit is amplified by a magnetic field effect of the permanent magnet of the static magnetic field unit to achieve the Hall effect and form a cell stack; and
a rectifying and charging unit being capable of rectifying the cell stack formed by the magnetic fuel cell stack forming unit and charging the cell stack to the buffer battery unit.

5. The magnetic fuel cell-based battery as claimed in claim 4, wherein the potential to kinetic energy converting unit is constituted by an electric damper of a switching controller; and an anti-electromotive force and eddy current out-coupled by a damping effect of the electrical damper is served as a kinetic energy input.
